(19) United States
(12) Patent Application Publication
(10) Pub. No.: US 2009/0297697 A1
(43) Pub. Date: Dec. 3, 2009

(54) Silver doped white metal particulates for conductive composites

(76) Inventor: Lester E. Burgess, Swarthmore, PA (US)

Correspondence Address: DILWORTH & BARRESE, LLP, 1000 WOODBURY ROAD, SUITE 405, WOODBURY, NY, 11797, US

(21) Appl. No.: 12/156,084

(22) Filed: May 29, 2008

(51) Int. Cl. B05D 5/12; H01B 1/22

(52) U.S. Cl. 427/125; 252/514

(57) ABSTRACT

A high shear method for making a conductive coating composition includes (a) adding with high shear agitation particles of one or more white metals having a melting point below 650° C. into a fluid with or without a reducing agent; and (b) adding with agitation silver particles into the fluid containing the particles of metals of step (a), wherein a polymer resin has been combined with the fluid.

### BACKGROUND

1. Field of the Invention

The present invention relates to electrically conductive compositions containing a polymer and conductive metal particulate filler.

2. Background of the Art

Various types of polymer-containing conductive composites are known in the art. Such composites are typically formulated in a fluid state as paints, pastes, inks, and the like, and applied to a substrate surface. The fluid is then cured or dried to provide a stable coating which can optionally be patterned to form sensor electrodes or antennas. The coatings can be used for radio frequency antennas tag, EMI shielding, for example, or as conductive gaskets, sealants or adhesives.

U.S. Pat. No. 4,371,459 to Nazarenko discloses a screen printable conductor composition including a conductive phase containing silver and base metal powders dispersed in a solution of a multipolymer in a volatile nonhydrocarbon solvent.

U.S. Pat. No. 4,545,926 to Fouts, Jr. et al. discloses a conductive polymer composition including a polymeric material having dispersed therein conductive particles composed of a highly conductive material and a particulate filler.

U.S. Pat. No. 5,866,044 to Saraf et al. discloses an electrically conductive paste which includes a thermoplastic polymer, a conductive metal powder and an organic solvent system.

U.S. Pat. No. 5,785,897 to Toufuku et al. discloses a coating solution for forming a transparent and electrically conductive film. The coating solution contains fine conductive metal or alloy particles dispersed in a polar solvent and having a diameter not exceeding 50 nm. The metal particles are of silver or silver alloy and at least one of palladium, copper and gold.

What is yet needed is a highly conductive coating material which is reliable, less costly and easy to make and apply.

### SUMMARY

A method for making a conductive coating composition is provided herein. The method comprises the steps of (a) adding with high shear agitation particles of one or more white metals having a melting point below 650□C into a fluid, wherein a polymer resin is combined with the fluid, with or without a reducing agent; (b) adding with high shear agitation silver particles into the fluid containing the particles of metals of step (a).

Also provided is a coating composition formulated by the method which, when applied to a substrate and then dried/and or cured, advantageously provides a highly conductive coating with reliable service life.

### DETAILED DESCRIPTION OF PREFERRED EMBODIMENT(S)

Other than in the working examples or where otherwise indicated, all numbers expressing amounts of materials, reaction conditions, time durations, quantified properties of materials, and so forth, stated in the specification and claims are to be understood as being modified in all instances by the term “about.”

It will also be understood that any numerical range recited herein is intended to include all sub-ranges within that range.

It will be further understood that any compound, material or substance which is expressly or implicitly disclosed in the specification and/or recited in a claim as belonging to a group of structurally, compositionally and/or functionally related compounds, materials or substances includes individual representatives of the group and all combinations thereof.

“Resistance” refers to the opposition of the material to the flow of electric current along the current path and is measured in ohms. Resistance increases in proportion to the length of the current path and the specific resistance, or “resistivity”, of the material, and it varies inversely to the amount of cross-sectional area available the current path. The resistivity is a property of the material and may be thought of as a measure of (resistance/length)×area. More particularly, the resistance may be determined in accordance with the following formula:

R=(ρL)/A (I)

wherein R=resistance in ohms
ρ=resistivity in ohm-inches
L=length in inches
A=area in square inches.

The current through a circuit varies in proportion to the applied voltage and inversely with the resistance as provided by Ohm's Law:

I=V/R (II)

wherein I=current in amperes
V=voltage in volts
R=resistance in ohms.

Typically, the resistance of a flat conductive sheet across the plane of the sheet, i.e., from one edge to the opposite edge, is measured in units of “ohms per square.” For any given thickness of the conductive sheet, the resistance value across the square remains the same no matter what the size of the square is.

The method of the invention includes a first step of providing a liquid medium, which can be a solvent capable of dissolving the polymer employed as the matrix in the composition of the invention. Alternatively, the liquid medium can be a vehicle or carrier in which the polymer forms a suspension or dispersion. Suitable liquid mediums include organic compounds such as unsubstituted hydrocarbons (e.g., hexane, heptane, cyclohexane, benzene toluene, xylene), substituted hydrocarbons (e.g., halohydrocarbons such as methylene chloride, dichloroethylene), alcohols (e.g., methanol, ethanol, propanol, butanol, cyclohexanol), ethers (e.g., ethyl ether, tetrahydrofuran), ketones (e.g., acetone, methylethyl ketone (MEK)), and esters (e.g., methyl acetate, ethyl acetate), or mixtures thereof. Preferred liquid medium for use in the invention is MEK, 1-Methoxy-2-Propanol (PM), 1-Methoxy-2-Propanol Acetate (PMA), Tertiary Butyl Acetate, N-Methylpyrrolidone (NMP).

Next, in an embodiment of the invention, a polymeric material is blended into the mixture. The polymeric material used in preparing the conductive compositions can be a thermoplastic, an elastomer or thermosetting resin or blends thereof.

Thermoplastic polymers suitable for use in the invention, may be crystalline or non-crystalline polymers. Illustrative examples are monomers such as vinyl esters, acids or esters of unsaturated organic acids or mixtures thereof, acrylic polymers such as polymethyl methacrylate, polycarbonates, halogenated vinyl polymers such as polyvinyl chloride, and copolymers of these monomers with each other or with other unsaturated monomers, polyesters, such as poly(hexamethylene adipate or sebacate), and the “Versamids” (condensation products of dimerized and trimerized unsaturated fatty acids, in particular linoleic acid with polyamines), polystyrene, polyurethane, polyacrylonitrile, thermoplastic silicone resins, thermoplastic polyethers, thermoplastic modified celluloses, and the like. The thermoplastic polymer can be cross-linked if desired.

Suitable elastomeric resins include rubbers, elastomeric gums and thermoplastic elastomers. The term “elastomeric gum”, refers to a polymer which is non-crystalline and which exhibits rubbery or elastomeric characteristics after being cross-linked. The term “thermoplastic elastomer” refers to a material which exhibits, in a certain temperature range, at least some elastomer properties; such materials generally contain thermoplastic and elastomeric moieties. The elastomeric resin need not be cross-linked when used in the compositions of this invention. At times, particularly when relatively low volumes of conductive particle and particulate filler are used, cross-linking may be advantageous.

Suitable elastomeric gums for use in the invention include, for example, polyisoprene (both natural and synthetic), ethylene-propylene random copolymers, poly(isobutylene), styrene-butadiene random copolymer rubbers, styreneacrylonitrile-butadiene terpolymer rubbers with and without added minor copolymerized amounts of unsaturated carboxylic acids, polyacrylate rubbers, polyurethane gums, random copolymers of vinylidene fluoride and, for example, hexafluoropropylene, polychloroprene, chlorinated polyethylene, chlorosulphonated polyethylene, polyethers, plasticized poly(vinyl chloride) containing more than 21% plasticizer, substantially non-crystalline random co- or ter-polymers of ethylene with vinyl esters or acids and esters of alpha, beta-unsaturated acids. Silicone gums and base polymers, for example poly(dimethyl siloxane), poly(methylphenyl siloxane) and poly(dimethyl vinyl siloxanes) can also be use.

Thermoplastic elastomers suitable for use in the invention, include graft and block copolymers, such as random copolymers of ethylene and propylene grafted with polyethylene or polypropylene side chains, and block copolymers of alpha-olefins such as polyethylene or polypropylene with ethylene/propylene or ethylene/propylene/diene rubbers, polystyrene with polybutadiene, polystyrene with polyisoprene, polystyrene with ethylene-propylene rubber, poly(vinylcyclohexane) with ethylene-propylene rubber, poly(alpha-methylstyrene) with polysiloxanes, polycarbonates with polysiloxanes, poly(tetramethylene terephthalate) with poly(tetramethylene oxide) and thermoplastic polyurethane rubbers.

Thermosetting resins capable of solution in the liquid medium can also be used. Conductive compositions of thermosetting resins which are solids at room temperature can be readily prepared using solution techniques. Typical thermosetting resins include epoxy resins, urethane, phenolics, etc.

Next, a reducing agent is added to the solvent for the purpose of removing and/or preventing the formation of electrically nonconductive compounds on the surface of the metal particles, such as oxide, hydroxide and the like. Suitable reducing agents include the aldehyde class of compounds and other organic reducing agent type compounds. High shear agitation, previously discussed, if suitably mix applied, will produce a functional conductive coating; however, the incorporation of an organic reducing agent offers the preferred formulation. Preferred reducing agents for use in the invention include organic reducing agents such as hydroquinone and formaldehyde.

The conductive metal filler particles include nonferrous white metals, i.e., metals that are solid at room temperature but which have a relatively low melting point of under 650° C. Such metals include antimony (Sb), bismuth (Bi), tin (Sn), gallium (Ga), lead (Pb), indium (In), cadmium (Cd), zinc (Zn), and mixtures and alloys thereof. Preferred alloys are eutectic alloys. Preferred is a bismuth-tin alloy having from about 58% Bi and about 42% Sn. The particles can be in the form of spheres, flakes or fibers, and typically have a size ranging from about 1 micron to about 80 microns. The preferred particle form is flake. Various alloys are listed in the Alloy Table below with their melting points.

ALLOY TABLE
(Composition percentages and melting point ranges ° C.)

| | | | | | | | | | |
|---|---|---|---|---|---|---|---|---|---|
| Bi | 44.7% | 49% | 50% | 42.5% | 52.5% | 48% | 55.5% | 58% | 40% |
| Pb | 22.6% | 16% | 26.7% | 37.7% | 32% | 28.5% | 44.5% | | |
| Sn | 8.3% | 12% | 13.3% | 11.3% | 15.5% | | | 42% | 60% |
| In | 19.1% | 21% | | | | | | | |
| Cd | 5.3% | | 10% | 8.5% | | 14.5% | | | |
| Sb | | | | | | 9% | | | |
| mp | 47° C. | 58° C. | 70° C. | 70-88° C. | 95° C. | 103-227° C. | 124° C. | 138° C. | 138-170° C. |
| ° C. | | | | | | | | | |

The white metal particles are added to the liquid medium and reducing agent with vigorous agitation. Mixing can be accomplished with, for example, a high speed blender, over a period of from about 1 to 10 minutes, or a 3-roll paint mill, using several mill passes. While not wishing to be bound by any theory, it is believed that the shear mixing forces the reducing agent, when used, onto the surfaces of the white metal particles.

Next, silver particles are shear mixed into the composition. The particles can be in the form of spheres, flakes or fibers, and typically have a size ranging from about 1 micron to about 80 microns. The preferred particle form is flake. The agitation must be sufficiently high shear, i.e., sufficiently vigorous to drive the silver flakes into the surfaces of the white metal particles and thereby achieve mechanical union of at least some of the silver flakes with the surfaces of at least some of the white metal particles such as by leafing. In other words, the surfaces of the white metal particles become at least partially coated, or laminated, with silver adhering thereto, and thereafter provide a highly conductive network form of composite morphology, with the silver component joining the white metal particulates. It is known to those skilled in the art that silver by itself, in weight amounts of less than 50 percent (ratio to resin) will not provide a conductive coating.

Shown by the formulae and procedures of the following Examples is the requirement of high shear mixing to critically morphologically network and create the silver flake/white metal particulate electrical connection relationship with the white metal particulate, thus establishing a conductive polymer composite ink. The comparative Examples are presented for purposes of illustration and do not exemplify the invention.

### EXAMPLE 1

### Illustration Formula 1 (Flake Silver Particulate Only, Solution Coating Ink):

TABLE 1

| | | Parts | % | | |
|---|---|---|---|---|---|
| | | by | Formula | | |
| Item | Material | Weight | Weight | Solids | % Solid |
| 1 | Elastomeric | 2 | 3.120125 | 2 | 5.865103 |
| | Resin* with | | | | |
| | Lewis Acid | | | | |
| | catalyst | | | | |
| 2 | Hydroquinone | 0.2 | 0.312012 | 0.2 | 0.58651 |
| 3 | Ag Flake | 31.9 | 49.76599 | 31.9 | 93.54839 |
| 4 | MEK | 30 | 46.80187 | 0 | 0 |
| Total | | 64.1 | 100 | 34.1 | 100 |

*Elastomeric Resin is an internally epoxidized derivative of hydroxyl-terminated polybutadiene and is used as the sole resin in this rubber like epoxy formulation

The solution coating conductive ink of Table 1 was prepared in accordance with the following procedure: First, the solvent was weighed into a 5 ounce glass container (normally used for a Preval spay gun; product of Precision Valve Corporation 700 Nepperhan Ave., Younkers, N.Y.). Second, the Elastomeric Resin (prepared with Lewis Acid Catalyst) was weighed into the same container and mixed with a high shear stirring mixer for 1 minute. Third, the silver flake was weighed separately and introduced into the same contain and mixed with a high shear stirring mixer for 5 minutes.

The resulting solution ink was spray applied onto the surface of a PET substrate masked with masking tape. This coating was warm blown air dried and this spray and drying procedure repeated two additional times. The masking tape was removed and the applied coating cured at 266° F. for 30 minutes. The film electrical resistance was measured by placing metal discs at each end of the deposit and measuring the electrical resistance with a multi-meter. This value was found to have a linear resistance of less than 0.2 ohms/5″ (¼″ wide) and a resistance of 0.01 ohms per square. (Note: The method of application has some variation, and lower and higher levels of conductance with the same conductive ink could result in different measured values. Variance of only ±20%, is considered very good.)

### EXAMPLE 2

Illustration Formula 2 (Illustrates the Use of Bi/Sn Alloy with Reducing Agent with Silver in a Ratio of 25.1 vol % Ag to 74.9 vol % as a Solution Coating Ink Formulation.):

TABLE 2

| | | Parts by | % Formula | | |
|---|---|---|---|---|---|
| Item | Material | Weight | Weight | Solids | % Solid |
| 1 | Elastomeric | 2 | 3.116236 | 2 | 5.851375 |
| | Resin* with | | | | |
| | Lewis Acid | | | | |
| | catalyst | | | | |
| 2 | Hydroquinone | 0.2 | 0.311624 | 0.2 | 0.585138 |
| 3 | Bi/Sn Alloy | 22.78 | 35.49392 | 22.78 | 66.64716 |
| 4 | Ag Flake | 9.2 | 14.33468 | 9.2 | 26.91633 |
| 5 | MEK | 30 | 46.74353 | 0 | 0 |
| Total | | 64.18 | 100 | 34.18 | 100 |

*Elastomeric Resin is an internally epoxidized derivative of hydroxyl-terminated polybutadiene and is used as the sole resin in this rubber like epoxy formulation

The conductive ink of Illustration Formula 2 was prepared in accordance with the following procedure: First, similar to Illustration Formula 1, the solvent was weighed into the same kind of 5 ounce glass container. Second, the Elastomeric Resin (prepared with Lewis Acid Catalyst) was weighed into the same container and mixed using a high shear stirring mixer for 1 minute. Third, the reducing agent, hydroquinone, was weighed separately and introduced into the same contain and mixed. Fourth, the Bi/Sn Alloy was weighed separately and introduced into the same contain and mixed with a high shear stirring mixer for 5 minutes. Fifth, silver, again, was weighed separately and introduced into the same contain and mixed with a high shear stirring mixer for 5 minutes. The resulting solution ink was spray applied onto the surface of a PET masked substrate. This coating was warm blown air dried and this spray and drying procedure repeated two additional times. The masking tape was removed and the applied coating cured at 266° F. for 30 minutes. The coating film's electrical resistance was similarly read. The composition coating's electrical resistance was linear resistance of 0.8 ohms/5″ (¼″ wide) and a sheet resistance of 0.07 ohms per square.

### EXAMPLE 3

Illustration Formula 3 (Illustrates the Use of Bi/Sn Alloy without Reducing Agent with Silver in a Ratio of 25.1 vol % Ag to 74.9 vol % Bi/Sn as a Solution Coating Ink Formulation.):

TABLE 3

| | | | % | | |
|---|---|---|---|---|---|
| | | Parts by | Formula | | |
| Item | Material | Weight | Weight | Solids | % Solid |
| 1 | Elastomeric | 2.00 | 3.13 | 2.00 | 5.89 |
| | Resin* with | | | | |
| | Lewis Acid | | | | |
| | catalyst | | | | |
| 2 | Hydroquinone | 0.00 | 0.00 | 0.00 | 0.00 |
| 3 | Bi/Sn Alloy | 22.78 | 35.60 | 22.78 | 67.04 |
| 4 | Ag Flake | 9.20 | 14.38 | 9.20 | 27.07 |
| 5 | MEK | 30.00 | 46.89 | 0.00 | 0.00 |
| Total | | 63.98 | 100.00 | 33.98 | 100.00 |

*Elastomeric Resin is an internally epoxidized derivative of hydroxyl-terminated polybutadiene and is used as the sole resin in this rubber like epoxy formulation

The conductive ink of Illustration Formula 3 was prepared in accordance with the following procedure: First, similar to Illustration Formula 1, the solvent was weighed into the same kind of 5 ounce glass container. Second, the Elastomeric Resin (prepared with Lewis Acid Catalyst) was weighed into the same container and mixed using a high shear-stirring mixer for 1 minute. Third, the Bi/Sn Alloy was weighed separately and introduced into the same contain and mixed with a high shear stirring mixer for 5 minutes. Fourth, silver, again, was weighed separately and introduced into the same container and mixed with a high shear stirring mixer for 5 minutes. The resulting solution ink was spray applied onto the surface of a PET masked substrate. This coating was warm blown air-dried and this spray and drying procedure repeated two additional times. The masking tape was removed and the applied coating cured at 266° F. for 30 minutes. The film electrical resistance was similarly read. This composition was tested for electrical resistance and found to have a linear resistance of 0.9 ohms/2.75″ (¼″ wide) and a sheet resistance of 0.08 ohms per square.

As summary, the results of preparing the solution conductive ink coatings showed that the resin system is compatible with both the silver flake particulate coating and the Bi/Sn Alloy particulate using high shear blending. Also shown was that the solution conductive ink coating could be prepared with or without reducing agent. The reducing agent serves to enhance the long term aging performance of the silver/white metal coating.

Paste ink coatings similarly were prepared using relatively low shear conditions as follows.

### EXAMPLE 4

### Illustration Formula 4 (Flake Silver Particulate Only, Paste Coating Ink):

TABLE 4

| | | Parts | % | | |
|---|---|---|---|---|---|
| | | by | Formula | | |
| Item | Material | Weight | Weight | Solids | % Solid |
| 1 | Elastomeric | 2.00 | 3.13 | 2.00 | 5.90 |
| | Resin* with | | | | |
| | Lewis Acid | | | | |
| | catalyst | | | | |
| 2 | Hydroquinone | 0.00 | 0.00 | 0.00 | 0.00 |
| 3 | Bi/Sn Alloy | 0.00 | 0.00 | 0.00 | 0.00 |
| 4 | Ag Flake | 31.90 | 49.92 | 31.90 | 94.10 |
| 5 | MEK | 30.00 | 46.95 | 0.00 | 0.00 |
| Total | | 63.90 | 100.00 | 33.90 | 100.00 |

*Elastomeric Resin is an internally epoxidized derivative of hydroxyl-terminated polybutadiene and is used as the sole resin in this rubber like epoxy formulation
** Drops of PMA Solvent was used to enhance the efficiency of the smear blend mixing procedure

The pure silver conductive paste ink of Illustration Formula 4 was prepared in accordance with the following procedure: First, the resin system was weighed onto a rigid 8″×10″ smooth Delrin plastic plate. Second, the reducing agent, Hydroquinone, was weighed and added to the plate, with the resin. The resin and hydroquinone were gathered together with a putty knife and smear mix blended by pressing the flat surface a spatula over these ingredients employing a circular spread path. This gathering and smearing action was repeated for several minutes. Third, the silver flake was weighed separately and introduced with the mix on the plate. The smear mixing technique was carried out for at least 5 minutes. Drops of PMA Solvent was used to improve the blending efficiency. The resulting paste ink was applied to a PET masked substrate (¼″ void space between the strips of tape by putty knife gap spread drawdown. This coating was warm blown air-dried. The masking tape was removed and the applied coating cured at 266° F. for 30 minutes. The film electrical resistance was measure similar the method of Illustration Formula 1 (Flake Silver Particulate Only Solution Coating Ink). This value was found to have a linear resistance of less than 0.6 ohms/2.75″ (¼ ′ wide) and a sheet resistance of 0.055 ohms per square. (Note: The method of application, has similar variation to the spray application method.) This result was very good and the paste provide an ink that could be applied by silk screening.

### EXAMPLE 5 (COMPARATIVE)

Illustration Formula 5 (Illustrates the Use of the Low Shear Mixing of the Bi/Sn with Silver in a Ratio of 25.1 vol % Ag to 74.9 vol % Bi/Sn in a Paste Ink Formulation.):

TABLE 5

| | | Parts | % | | |
|---|---|---|---|---|---|
| | | by | Formula | | |
| Item | Material | Weight | Weight | Solids | % Solid |
| 1 | Elastomeric | 2 | 3.116236 | 2 | 5.851375 |
| | Resin* with | | | | |
| | Lewis Acid | | | | |
| | catalyst | | | | |
| 2 | Hydroquinone | 0.2 | 0.311624 | 0.2 | 0.585138 |
| 3 | Bi/Sn Alloy | 22.78 | 35.49392 | 22.78 | 66.64716 |
| 4 | Ag Flake | 9.2 | 14.33468 | 9.2 | 26.91633 |
| 5 | PMA | 30 | 46.74353 | 0 | 0 |
| Total | | 64.18 | 100 | 34.18 | 100 |

*Elastomeric Resin is an internally epoxidized derivative of hydroxyl-terminated polybutadiene and is used as the sole resin in this rubber like epoxy formulation
**Drops of PMA Solvent was used to enhance the efficiency of the smear blend mixing procedure

The conductive ink of Illustration Formula 5 was prepared similar to Illustration Formula 4 except that the third step was changed to the Bi/Sn Alloy being weighed separately and introduced onto the Delrin plastic plate and smear mixed for 5 minutes. Fourth, silver, was weighed separately and introduced with the smear blend method of the third step. The resulting Bi/Sn Alloy paste ink was applied to a PET masked substrate similar to Illustration Formula 4. Again, this coating was warm blown air dried and the masking tape was removed and the applied coating cured at 266° F. for 30 minutes. The film electrical resistance was similarly read. This composition was tested for electrical resistance and found to have resistance so high as to allow substantially no electrical conductance.

This electrically open circuit outcome, when compared to that of the silver-alone paste ink of Example 4, which was very conductive, shows that the high shear is necessary for incorporating the relationship of the silver flake particulate with the white metal particulate to obtain conductive plastic composite properties.

The volume percentage of silver in the combined white metal/silver conductive filler should be at least 3% and preferably ranges from about 5% to about 90%, by volume, more preferably from about 5% to about 50%, and yet more preferably from about 10% to about 35%. A formulation containing the above components can have the following ranges of component weight percentages:

| Component | Broad Range | Preferred range |
|---|---|---|
| Polymer | 3 wt %-40 wt % | 5 wt %-30 wt % |
| Reducing agent | 0.5 wt %-10 wt % | 1 wt %-5 wt % |
| White metal | 5 wt %-95 wt % | 50 wt %-90 wt % |
| Silver | 5 wt %-95 wt % | 10 wt %-50 wt % |
| Liquid medium | 2 wt % 50 wt % | 5 t %-30 wt % |

The formulation herein is applied to a substrate by any suitable means such as spraying, casting, roller application, silk screening, rotogravure printing, knife coating, curtain coating, offset coating, extrusion glue head coating or other suitable method. The coating layer can be patterned to provide an antenna configuration, electrical circuit, or a shaped electrode. After application the coating formulation is dried by evaporation of the liquid medium with or without heating. The substrate can be any suitable nonconductive material such as polymer film (ex. PET, acrylic, polycarbonate, polyester, polyvinylchloride, EPDM rubber, etc.) or foamed polymer, and can be elastomeric, flexible, or rigid sheet.

Selection of the appropriate white metal can depend on various considerations. For example, lead is not preferred in many applications because of its toxicity. The use of various low melting metals can depend on the ambient temperatures in which they will be used. Generally, a particular white metal will not be suitable if the expected ambient temperature is above the melting point of the metal.

### EXAMPLES 6-19

In the following examples and comparative examples the polymer component used was a solution of 28% polyurethane solids in tetrahydrofuran and MEK, (also non-HAP solvent blends). The reducing agent was hydroquinone. Additional solvent, MEK, was added to the polymer solution as a diluent to reduce the viscosity of the fluid.

In all of the following examples and comparative examples the components of the formulations were mixed as follows. The reducing agent was added to the polymer solution. Then MEK was added to the solution as a solvent to lower the viscosity. Then the white metal particles were shear mixed into the solvent using a high speed blender. Next, silver flakes were shear mixed into the solvent using the high speed blender. The blending of both the white metal and silver was conducted over a period of about 5 minutes.

The coating formulations were applied to PET, polycarbonate and polyvinylchloride (PVC) thin sheet strips and were allowed to dry (and thermally cure, according to the resin system) to form a coating film. The films on the coated strips were tested for electrical resistivity by contacting the ends of the strips with a silver/copper conductive disk and then measuring the resistance along the film with an ohm meter. The readings were then recorded.

Age testing of the coated strips was performed by heating the strips over a length of time in an oven controlled at a temperature of 167° F. (75° C.). Strips with a Tin/Silver coating formulation was successfully age tested at 85° C. for over 2000 hours. The strips were periodically removed during the test period after predetermined intervals, allowed to cool and then tested for electrical resistance. The increase in resistance indicated the degree of aging, i.e., degradation over a period of time. The basis for thermal testing to determine aging resistance is that reaction rates approximately double for each 10° C. increase in temperature.

### EXAMPLE 6 (COMPARATIVE)

This comparative example illustrates the use of lead particles as the white metal without combination with silver. The following components were combined in the percentages set forth below in Table 6 and spray, mask applied to a PET substrate.

TABLE 6

| | | Weight | % Formula | Solids | Wt % |
|---|---|---|---|---|---|
| Item | Material | (parts) | weight | (parts) | Solids |
| 1 | 28% | 4 | 8.658009 | 1.12 | 4.802744 |
| | Polyurethane | | | | |
| | Resin solution | | | | |
| 2 | Hydroquinone | 0.2 | 0.4329 | 0.2 | 0.857633 |
| 3 | Pb | 22 | 47.61905 | 22 | 94.33962 |
| 4 | Ag flake | 0 | 0. | 0 | 0 |
| 5 | MEK | 20 | 43.29004 | 0 | 0 |
| Total | | 46.2 | 100.00 | 23.32 | 100 |

This composition was tested for electrical resistance and found to have resistance so high as to allow substantially no electrical conductance.

### EXAMPLE 7

This Example illustrates the use of lead with silver in a ratio of 52 vol % Ag to 48 vol % Pb formulation. The formulation was prepared in accordance with the method described above. The following components were combined in the weight percentages as indicated below in Table 7.

TABLE 7

| | | Weight | % Formula | Solids | Wt % |
|---|---|---|---|---|---|
| Item | Material | (parts) | weight | (parts) | Solids |
| 1 | 28% | 4 | 9.950249 | 1.12 | 6.47 |
| | Polyurethane solution | | | | |
| 2 | Hydroquinone | 0.2 | 0.497512 | 0.2 | 1.15 |
| 3 | Pb | 8 | 19.9005 | 8 | 46.19 |
| 4 | Ag flake | 8 | 19.9005 | 8 | 46.19 |
| 5 | MEK | 20 | 49.75124 | 0 | 0 |
| Total | | 40.2 | 100 | 17.32 | 100 |

Coatings prepared with formula of Table 7 were very conductive. This composition was tested for electrical resistance and found to have a linear resistance of less 0.1 ohms/2.75″ (¼″ wide) and a sheet resistance of 0.009 ohms per square.

### EXAMPLE 8

This Example illustrates the use of lead with silver in a ratio of 22 vol % Ag to 78 vol % Pb formulation. The formulation was prepared in accordance with the method described above. The following components in the weight percentages as indicated below in Table 8.

TABLE 8

| | | Weight | % Formula | Solids | Wt % |
|---|---|---|---|---|---|
| Item | Material | (parts) | weight | (parts) | Solids |
| 1 | 28% | 2 | 4.975124 | 0.56 | 3.008165 |
| | Polyurethane | | | | |
| | solution | | | | |
| 2 | Hydroquinone | 0.2 | 0.497512 | 0.056 | 0.300817 |
| 3 | Pb | 13.5 | 33.58209 | 13.5 | 72.51826 |
| 4 | Ag flake | 4.5 | 11.19403 | 4.5 | 24.17275 |
| 5 | MEK | 20 | 49.75124 | 0 | 0 |
| Total | | 40.2 | 100 | 18.616 | 100 |

Coatings Prepared with Formula of Table 8 were very Conductive. This was not Recorded but Lead to further Investigations.

### EXAMPLE 9

This Example illustrates the use of lead with silver in a ratio of 4.4 vol % Ag to 95.6 vol % Pb formulation. The formulation was prepared in accordance with the method described above. The following components were combined in the weight percentages as indicated below in Table 9.

TABLE 9

| | | Weight | % Formula | Solids | Wt % |
|---|---|---|---|---|---|
| Item | Material | (parts) | weight | (parts) | Solids |
| 1 | 28% | 2 | 4.889976 | 0.56 | 3.135498 |
| | Polyurethane | | | | |
| | solution | | | | |
| 2 | Hydroquinone | 0.2 | 0.488998 | 0.2 | 1.119821 |
| 3 | Pb | 16.2 | 39.6088 | 16.2 | 90.70549 |
| 4 | Ag flake | 0.9 | 2.200489 | 0.9 | 5.039194 |
| 5 | MEK | 20 | 48.89976 | 0 | 0 |
| Total | | 39.3 | 96.08802 | 17.86 | 100 |

This composition was tested for electrical resistance and found to have a linear resistance of 0.1 ohms/5″ (¼″ wide) and a sheet resistance of 0.01 ohms per square.

### EXAMPLE 10

This Example illustrates the use of the lead with silver in a ratio of 10.5 vol % Ag to 89.5 vol % Pb formulation. The formulation was prepared in accordance with the method described above. The following components were combined in the weight percentages as indicated below in Table 10.

TABLE 10

| | | Weight | % Formula | Solids | Wt % |
|---|---|---|---|---|---|
| Item | Material | (parts) | weight | (parts) | Solids |
| 1 | 28% | 2 | 4.81 | 0.56 | 2.78 |
| | Polyurethane solution | | | | |
| 2 | Hydroquinone | 0.2 | 0.48 | 0.2 | 0.99 |
| 3 | Pb | 17 | 440.87 | 17 | 84.33 |
| 4 | Ag flake | 2.4 | 5.77 | 2.4 | 11.90 |
| 5 | MEK | 20 | 46.08 | 0 | 0 |
| Total | | 41.6 | 100 | 20.16 | 100 |

This composition was tested for electrical resistance and found to have a linear resistance of 0.8 ohms/3″ (¼″ wide) and a sheet resistance of 0.07 ohms per square.

### EXAMPLE 11 (COMPARATIVE)

This Comparative Example illustrates the use of bismuth-tin eutectic alloy (58% Bi/42% Sn) without combination with silver. The formulation was prepared in accordance with the method described above. The following components were combined in the weight percentages indicated below in Table 11.

TABLE 11

| | | Weight | % Formula | Solids | Wt % |
|---|---|---|---|---|---|
| Item | Material | (parts) | weight | (parts) | Solids |
| 1 | 28% | 2 | 5.602241 | 0.56 | 3.9 |
| | Polyurethane solution | | | | |
| 2 | Hydroquinone | 0.2 | 0.560224 | 0.2 | 1.4 |
| 3 | Bi—Sn eutectic | 13.5 | 37.81513 | 13.5 | 94.7 |
| | alloy | | | | |
| 4 | Ag flake | 0 | 0 | 0 | 0 |
| 5 | MEK | 20 | 56.02241 | 0 | 0 |
| Total | | 35.7 | 100 | 14.26 | 100 |

This composition was tested for electrical resistance and found to have resistance so high as to allow substantially no electrical conductance.

### EXAMPLE 12

This Example illustrates the use of Bi/Sn eutectic alloy with silver in a ratio of 20.6 vol % Ag to 79.4 vol % Bi/Sn formulation. The formulation was prepared in accordance with the method described above. The following components were combined in the weight percentages as indicated below in Table 12.

TABLE 12

| | | Weight | % Formula | Solids | Wt % |
|---|---|---|---|---|---|
| Item | Material | (parts) | weight | (parts) | Solids |
| 1 | 28% | 1 | 1.915109 | 0.28 | 1.3 |
| | Polyurethane solution | | | | |
| 2 | Hydroquinone | 0.2 | 0.383142 | 0.2 | 0.9 |
| 3 | Bi—Sn eutectic | 16 | 30.65134 | 16 | 74.5 |
| | alloy | | | | |
| 4 | Ag flake | 5 | 9.578544 | 5 | 23.3 |
| 5 | MEK | 30 | 57.47126 | 0 | 0 |
| Total | | 52.2 | 100 | 21.48 | 100 |

This composition was tested for electrical resistance and found to have a linear resistance of 0.4 ohms/2.75″ (¼″ wide) and a sheet resistance of 0.04 ohms per square.

### EXAMPLE 13

This Example illustrates the use of Bi/Sn eutectic alloy with silver in a ratio of 12.8 vol % Ag to 87.2 vol % Bi/Sn formulation. The formulation was prepared in accordance with the method described above. The following components were combined in the weight percentages indicated below in Table 8.

TABLE 13

| | | Weight | % Formula | Solids | Wt % |
|---|---|---|---|---|---|
| Item | Material | (parts) | weight | (parts) | Solids |
| 1 | 28% | 0.9 | 1.761252 | 0.252 | 1.2 |
| | Polyurethane solution | | | | |
| 2 | Hydroquinone | 0.2 | 0.391389 | 0.2 | 1 |
| 3 | Bi—Sn eutectic | 17 | 33.2681 | 17 | 83.1 |
| | alloy | | | | |
| 4 | Ag flake | 3 | 5.870841 | 3 | 14.7 |
| 5 | MEK | 30 | 58.70841 | 0 | 0 |
| Total | | 51.1 | 100 | 20.452 | 100 |

This composition was tested for electrical resistance and found to have a linear resistance of 1.1 ohms/2.75″ (¼″ wide and a sheet resistance of 0.1 ohms per square.

### EXAMPLE 14 (COMPARATIVE)

This Comparative Example illustrate the use of tin without combination with silver. The formulation was prepared in accordance with the method described above. The following components were combined in the weight percentages indicated below in Table 14.

TABLE 14

| | | Weight | % Formula | Solids | Wt % |
|---|---|---|---|---|---|
| Item | Material | (parts) | weight | (parts) | Solids |
| 1 | 28% | 7.1 | 14.8847 | 1.988 | 15.97557 |
| | Polyurethane | | | | |
| | solution | | | | |
| 2 | Hydroquinone | 0.2 | 0.419287 | 0.056 | 0.450161 |
| 3 | Sn | 10.4 | 21.80294 | 10.4 | 83.57441 |
| 4 | Ag flake | 0 | 0 | 0 | 0 |
| 5 | MEK | 30 | 62.89308 | 0 | 0 |
| Total | | 47.7 | 100 | 12.444 | 100 |

This composition was tested for electrical resistance and found to have resistance so high as to allow substantially no electrical conductance.

### EXAMPLE 15

This Example illustrates the use of tin in combination with silver in a ratio of 32.6 vol % Ag to 67.4 vol % Sn formulation. The formulation was prepared in accordance with the method described above. The following opponents were combined in the weight percentages indicated below in Table 15.

TABLE 15

| | | Weight | % Formula | Solids | Wt % |
|---|---|---|---|---|---|
| Item | Material | (parts) | weight | (parts) | Solids |
| 1 | 28% | 7.0 | 12.45552 | 1.96 | 9.30 |
| | Polyurethane solution | | | | |
| 2 | Hydroquinone | 0.2 | 0.355872 | 0.2 | 0.95 |
| 3 | Sn | 12 | 21.35231 | 12 | 56.70 |
| 4 | Ag flake | 7 | 12.45552 | 7 | 33.05 |
| 5 | MEK | 30 | 53.38078 | 0 | 0 |
| Total | | 56.2 | 100 | 15.044 | 100 |

This composition was tested for electrical resistance and found to have a linear resistance of 0.8 ohms/2.75″ (¼″ wide) and a sheet resistance of 0.07 ohms per square.

### EXAMPLE 16

This Example illustrates the use of tin in combination with silver in ratio of 20.6 vol % Ag to 79.4 vol % Sn formulation. The formulation was prepared in accordance with the method described above. The following components were combined in the weight percentages indicated below in Table 16.

TABLE 16

| | | Weight | % Formula | Solids | Wt % |
|---|---|---|---|---|---|
| Item | Material | (parts) | weight | (parts) | Solids |
| 1 | 28% | 1 | 1.915709 | 0.28 | 1.3 |
| | Polyurethane solution | | | | |
| 2 | Hydroquinone | 0.2 | 0.383142 | 0.2 | 0.9 |
| 3 | Sn | 16 | 30.65134 | 16 | 74.5 |
| 4 | Ag flake | 5 | 9.578544 | 5 | 23.3 |
| 5 | MEK | 30 | 57.47126 | 0 | 0 |
| Total | | 52.2 | 100 | 21.48 | 100 |

This composition was tested for electrical resistance and found to have a linear resistance of 0.5 ohms/2.75″ (¼″ wide) and a sheet resistance of 0.05 ohms per square.

### EXAMPLE 17

This Example also illustrates the use of tin in combination with silver in ratio of 28.5 vol % Ag to 71.5 vol % Sn formulation. The formulation was made in accordance with the method described above. The following components were combined in the weight percentages indicated below in Table 17.

TABLE 17

| | | Weight | % Formula | Solids | Wt % |
|---|---|---|---|---|---|
| Item | Material | (parts) | weight | (parts) | Solids |
| 1 | 28% | 9 | 16.48352 | 2.52 | 13.9 |
| | Polyurethane solution | | | | |
| 2 | Hydroquinone | 0.2 | 0.3663 | 0.056 | 1.1 |
| 3 | Sn | 10.4 | 19.04762 | 10.4 | 57.4 |
| 4 | Ag flake | 5 | 9.157509 | 5 | 27.6 |
| 5 | MEK | 30 | 54.94505 | 0 | 0 |
| Total | | 54.6 | 100 | 17.976 | 100 |

This composition was tested for electrical resistance and found to have a linear resistance of 0.4 ohms/2.75″ (¼″ wide) and a sheet resistance of 0.04 ohms per square.

### EXAMPLE 18

This Example illustrates the use of tin in combination with silver in a ratio of 13.5 vol % Ag to 86.5 vol % Sn formulation. The formulation was made in accordance with the method described above. The following components were combined in the weight percentages indicated below in Table 18.

TABLE 18

| | | Weight | % Formula | Solids | Wt % |
|---|---|---|---|---|---|
| Item | Material | (parts) | weight | (parts) | Solids |
| 1 | 28% | 2 | 3.91 | 0.56 | 2.8 |
| | Polyurethane solution | | | | |
| 2 | Hydroquinone | 0.2 | 0.39 | 0.2 | 1 |
| 3 | Sn | 16 | 31.25 | 16 | 81 |
| 4 | Ag flake | 3 | 5.86 | 3 | 15.2 |
| 5 | MEK | 30 | 58.59 | 0 | 0 |
| Total | | 51.2 | 100 | 19.76 | 100 |

This composition was tested for electrical resistance and found to have a linear resistance of 1.6 ohms/5″ (¼″ wide) and a sheet resistance of 0.08 ohms per square.

### EXAMPLE 19

Samples of strips coated with the coating formulation of the invention were tested for thermal aging in accordance with the method described above. The following results were obtained for the conductive filler compositions set forth below in Table 19.

TABLE 19
(Resistance in ohms at time exposure to 75° C. ambient temperature)

| | Hours | | | | | | | | |
|---|---|---|---|---|---|---|---|---|---|
| Samples | 0 | 24 | 28 | 72 | 144 | 264 | 312 | 408 | 600 |
| 75% Bi/ | 0.4 | 0.4 | 0.4 | 0.4 | 0.3 | 0.6 | 0.5 | 0.5 | 0.5 |
| Sn | | | | | | | | | |
| alloy - | | | | | | | | | |
| 25% Ag | | | | | | | | | |
| 90% Bi/ | 0.2 | 0.2 | 0.1 | 0.15 | 0.2 | 0.2 | 0.2 | 0.2 | 0.2 |
| Sn | | | | | | | | | |
| alloy - | | | | | | | | | |
| 10% Ag | | | | | | | | | |
| 50% Bi/ | 0.01 | 0.01 | 0.01 | 0.01 | 0.01 | 0.05 | 0.05 | 0.05 | 0.05 |
| Sn | | | | | | | | | |
| alloy - | | | | | | | | | |
| 50% Ag | | | | | | | | | |
| 95% Bi/ | 0.8 | 0.3 | 0.6 | 0.5 | 0.6 | 0.6 | 0.6 | 0.6 | 0.8 |
| Sn | | | | | | | | | |
| alloy - | | | | | | | | | |
| 5% Ag | | | | | | | | | |

As can be seen from the above Table 19, the composition of the invention is stable over a period of time. These results were the about the same after 1500 hours.

While the above description contains many specifics, these specifics should not be construed as limitations of the invention, but merely as exemplifications of preferred embodiments thereof. Those skilled in the art will envision many other embodiments within the scope and spirit of the invention as defined by the claims appended hereto.

What is claimed is:

1. A method for making a conductive coating composition comprising:
a) combining a polymer resin with a fluid;
b) adding with agitation a reducing agent;
c) adding with high shear agitation particles of one or more white metals having a melting point below 650° C. into the liquid medium containing a reducing agent
d) adding with high shear agitation silver particles into the liquid medium containing the particles of metals of step (c).

2. The method of claim 1 wherein the white metal is selected from the group consisting of antimony, bismuth, gallium, tin, lead, indium, cadmium, zinc and mixtures and alloys thereof.

3. The method of claim 1 wherein the white metal is bismuth-tin alloy having 58 wt % bismuth and 42 wt % tin.

4. The method of claim 1 wherein the silver particles are in the form of silver flakes.

5. The method of claim 1 wherein the liquid medium includes an organic compound selected from the group consisting of unsubstituted and substituted hydrocarbons, alcohols, ethers, ketones and esters.

6. The method of claim 5 wherein the liquid medium is methyl ethyl ketone.

7. The method of claim 1 wherein the reducing agent is an organic compound selected from the group consisting of hydroquinone and formaldehyde.

8. The method of claim 1 wherein the polymer is selected from the group consisting of polyurethane, polyvinylchloride, polyolefins, acrylic polymers, natural and synthetic rubber.

9. A method for making a conductive coating composition comprising:
a) combining polymer resin with a fluid.
b) adding with high shear agitation particles of one or more white metals having a melting point below 650° C. into the liquid medium containing; a reducing agent
c) adding with high shear agitation silver particles into the liquid medium containing the particles of metals of step (b).

10. The method of claim 9 wherein the white metal is selected from the group consisting of antimony, bismuth, gallium, tin, lead, indium, cadmium, zinc and mixtures and alloys thereof.

11. The method of claim 9 wherein the white metal is bismuth-tin alloy having 58 wt % bismuth and 42 wt % tin.

12. The method of claim 9 wherein the silver particles are in the form of silver flakes.

13. The method of claim 9 wherein the liquid medium includes an organic compound selected from the group consisting of unsubstituted and substituted hydrocarbons, alcohols, ethers, ketones and esters.

14. The method of claim 13 wherein the liquid medium is methyl ethyl ketone, 1-methoxy-2-propanol (PM), 1-methoxy-2-propanol Acetate (PMA), tert-butyl acetate, or N-methylpyrrolidone (NMP).

15. The method of claim 9 wherein the reducing agent is an organic compound selected from the group consisting of hydroquinone and formaldehyde.

16. The method of claim 9 wherein the polymer is selected from the group consisting of polyurethane, polyvinylchloride, polyolefins, acrylic polymers, natural and synthetic rubber.

17. A method for making a conductive coating composition comprising:
a) providing particles of white metal having a melting point of less than 650° C.;
b) adding said white metal particles to a liquid medium containing a reducing agent;
c) treating said white metal particles using high shear blending with said reducing agent to remove electrically nonconductive compounds on surfaces of the white metal particles;
d) adding silver particles to the liquid medium using high shear blending after said particles have been treated in step (c); and
e) high shear mechanically impact bonding at least some of the silver particles to the surfaces of at least some of the treated white metal particles.

18. The method of claim 17 wherein the liquid medium also includes a polymer.

19. The method of claim 17 wherein the white metal is selected from the group consisting of antimony, bismuth, gallium, tin, lead, indium, cadmium, zinc and mixtures and alloys thereof.

20. The method of claim 9 wherein the metal is bismuth-tin alloy having 58 wt % bismuth and 42 wt % tin.

21. The method of claim 17 wherein the silver particles are in the form of silver flakes.

22. The method of claim 17 wherein the liquid medium includes an organic compound selected from the group consisting of unsubstituted and substituted hydrocarbons, alcohols, ethers, ketones and esters.

23. The method of claim 22 wherein the liquid medium is methyl ethyl ketone.

24. The method of claim 17 wherein the reducing agent is an organic compound selected from the group consisting of hydroquinone and formaldehyde.

25. The method of claim 17 wherein the polymer is selected from the group consisting of polyurethane, polyvinylchloride, polyolefins, acrylic polymers, natural and synthetic rubber.

26. A coating composition comprising:
a) a polymeric material; and
b) a conductive filler which includes particles of metal having surfaces at least partially coated with silver mechanically bonded thereto, wherein the metal is selected from the group consisting of antimony, bismuth, gallium, tin, lead, indium, cadmium, zinc and mixtures and alloys thereof.

27. The method of claim 26 wherein the metal is bismuth-tin alloy having from about 58 wt % bismuth and about 42 wt % tin.

27. A coating formulation comprising:
a) a liquid medium including a solvent, a polymer dissolved or dispersed in said solvent, and a reducing agent; and
b) a conductive filler which includes particles of metal having surfaces at least partially coated with silver mechanically bonded thereto, wherein the metal is selected from the group consisting of antimony, bismuth, gallium, tin, lead, indium, cadmium, zinc and mixtures and alloys thereof.

28. A method of coating a substrate comprising:
a) providing a fluid coating formulation including
i. a liquid medium including a solvent, a polymer dissolved or dispersed in said solvent; and
ii. a conductive filler which includes particles of metal having surfaces at least partially coated with silver mechanically bonded thereto, wherein the metal is selected from the group consisting of antimony, bismuth, gallium, tin, lead, indium, cadmium, zinc and mixtures and alloys thereof;
b) applying said fluid coating formulation to the substrate; and
c) drying said substrate by evaporation of the solvent to provide an electrically conductive coating on the substrate.

29. The method of claim 28 wherein the liquid medium further includes an organic soluble reducing agent.

30. The method of claim 29 wherein the reducing agent is hydroquinone or formaldehyde.
